(19) United States
(12) Patent Application Publication
(10) Pub. No.: US 2013/0089677 A1
(43) Pub. Date: Apr. 11, 2013

(54) Method For Applying Hot Melt Adhesive Powder Onto A Shoe Or Sole Part

(71) Applicants: Jakov Makover, Maccabim (IL); Bar Cochva Mardix, Tel Aviv (IL); Yaacov Sadeh, Rechovot (IL)

(72) Inventors: Jakov Makover, Maccabim (IL); Bar Cochva Mardix, Tel Aviv (IL); Yaacov Sadeh, Rechovot (IL)

(73) Assignee: ORISOL ASIA LTD. a Taiwan Company, Fu Hsin Hsian (TW)

(21) Appl. No.: 13/632,949

(22) Filed: Oct. 1, 2012

Related U.S. Application Data
(63) Continuation-in-part of application No. 12/530,199, filed on Sep. 4, 2009, now abandoned.

(51) Int. Cl. B05D 5/10; B05D 3/10; B05D 3/02; B05D 3/06

(52) U.S. Cl. 427/553

(57) ABSTRACT

A method for applying hot melt adhesive powder onto a sole or shoe part includes the steps of applying a cleaning agent, irradiating, applying a conductive liquid which has a conductivity at least 100 times higher than water, spraying hot melt adhesive powder; and heating. The method can save energy, reduce the working space, reduce the labor intensity and improve the working environment by making the spraying and the melting operation of the hot melt adhesive carry out automatically.

This application is a continuation in part of U.S. patent application Ser. No. 12/530,199, which claims the benefit of the earlier filing date of Sep. 4, 2009. Claims 1 and 2 of this application are revised from claims 1 and 2 of U.S. patent application Ser. No. 12/530,199, claim 4 is new, and claim 3 correspond to claim 4 of U.S. patent application Ser. No. 12/530,199.

### BACKGROUND OF THE INVENTION

1. Field of the Invention

The present invention relates to a method for using hot melt adhesive powder to bond two non-metallic shoe or sole parts; and more particularly to a method for applying hot melt adhesive powder onto a sole surface.

2. Description of the Prior Art

Conventional ways of bonding two non-metallic shoes are mostly to apply liquid adhesive on the to-be-bonded areas of the soles so as to bond them together. The to-be-bonded areas don't have uniform shapes, it requires manual effort to apply adhesive, so it is labor-intensive. For example, the gluing of shoe parts and sole parts or the gluing of soles to uppers includes steps of manually applying solvent or water based liquids onto the shoe parts, manually applying the liquid water or solvent based adhesives, and consuming high level of energy to evaporate the water or other non adhesive fluid. Since a common solvent based adhesive contains some toxic substances, such as benzene, formaldehyde, and etc, the working environment is bad for the health of the workers.

The present invention has arisen to mitigate and/or obviate the afore-described disadvantages.

### SUMMARY OF THE INVENTION

The primary objective of the present invention is to provide a method for applying hot melt adhesive powder onto sole parts or shoe parts surfaces which can save energy, reduce the working space, reduce the labor intensity and improve the working environment by making the spraying and the melting operation of the hot melt adhesive carry out automatically.

In order to achieve the above objective, the method for applying hot melt adhesive powder onto a sole or shoe part comprises the steps of:

applying cleaning agent: a cleaning agent is applied onto a to-be-bonded area of a surface of a to-be-bonded shoe;

irradiating: the surface of the to-be-bonded shoe is irradiated in a irradiation chamber by ultraviolet rays and ozone;

applying conductive liquid: a conductive liquid which has a conductivity at least 100 times higher than water is applied onto the to-be-bonded area of the to-be-bonded shoe parts;

spraying hot melt adhesive powder: charged hot melt adhesive powder is sprayed onto the surface of the to-be-bonded shoe parts in a spraying chamber to make the charged hot melt adhesive powder attached onto the to-be-bonded area of the to-be-bonded shoe parts under the effect of an electrostatic field; and

heating: the to-be-bonded area on which is sprayed the hot melt adhesive powder is heated in a heating chamber to melt the hot melt adhesive powder.

### BRIEF DESCRIPTION OF THE DRAWINGS

FIG. 1 is a schematic view illustrating a system and a method for applying hot melt adhesive powder onto a sole surface.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

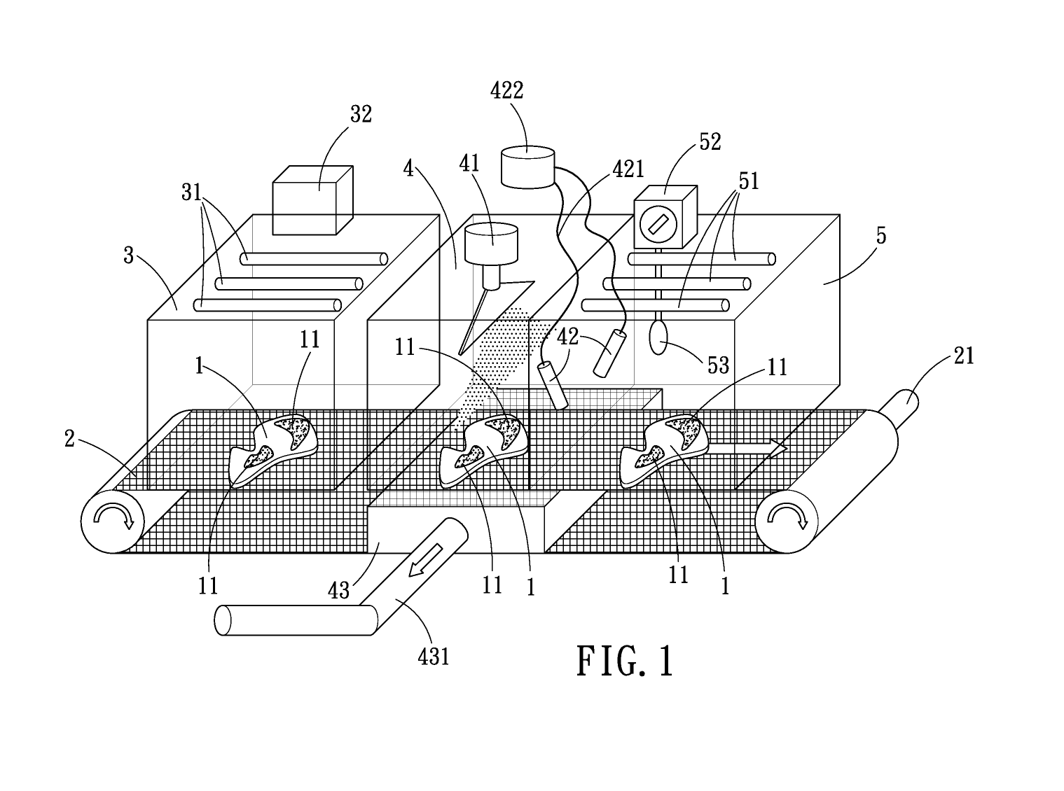

FIG. 1 illustrates a method and a system for applying hot melt adhesive powder onto a sole surface.

The system for applying hot melt adhesive powder onto a sole surface comprises a convey belt 2, an irradiation chamber 3, a spraying chamber 4 and a heating chamber 5.

The method for applying hot melt adhesive powder onto a sole or shoe part comprises the steps of:

A. applying cleaning agent: a cleaning agent (available on the market) is applied onto a to-be-bonded sole or shoe part 1 (in the present embodiment, onto a to-be-bonded area 11 of a surface of the shoe part 1) by a brush or a spraying gun;

B. irradiating: the surface of the shoe part 1 is irradiated in the irradiation chamber 3 by ultraviolet rays and ozone, the irradiation chamber 3 is located above the convey belt 2, the shoe part 1 is delivered into the irradiation chamber 3 by the convey belt 2, the irradiation chamber 3 is provided with at least one ultraviolet lamp 31, optimally UV-C lamp (three in the present embodiment) inside thereof to irradiate the shoe part 1 (the use of the UV-C lamp in collaboration with the primer has proved to unnecessitate and replace the use of B-powder, which is used to halogenate rubber prior to cementing and hazardous to human health), the irradiation chamber 3 is further provided with an ozone generator 32 to provide ozone into the irradiation chamber 3 to make the UV irradiation carry out in the ozone environment to enhance the irradiation effect, the ozone level inside the chamber 3 can be controlled by the ozone generator 32, the to-be-bonded area 11 of the shoe part 1 can receive better irradiation effect than the non-cleaned part, the speed of the convey belt 2 is adjusted according to the length of the irradiation chamber 3 to ensure the shoe part 1 to be irradiated;

C. applying high conductive liquid: a high conductive liquid (the conductive liquid should be of high conductivity and not just water and has a conductivity at least 100 times higher than the water, such conductive liquid is the CORVEL®MOR-PREP supplied by Morton Power Coating Co. of the USA,) is applied onto the to-be-bonded area 11 by a brush or a spraying gun, and then the shoe 1 which is coated with the high conductive liquid will be placed on the convey belt 2 which is driven by a variable speed motor 21 or a driver;

D. spraying hot melt adhesive powder: the hot-met adhesive powder is optimally a polyurethane hot melt adhesive powder or TPU (thermo plastic Polyurethane), which can be melted at a given temperature, the spraying chamber 4 is located above the convey belt 2, and the shoe part 1 which has been subjected to irradiation will be delivered into the spraying chamber 4 by the convey belt 2, the spraying chamber 4 is provided with at least one spray head 41 (one in the present embodiment) at an upper side thereof. The spray head 41 can charge the hot-met adhesive powder with electrostatic charges and be connected to an air pressurized powder chamber (not shown). The air pressurized powder chamber can deliver the hot melt adhesive powder to the spray head 41 by air pressure first, and then the hot-met adhesive will be charged with the electrostatic charges by the spray head 41 and subsequently sprayed onto the surface of the shoe part 1, since the to-be-bonded area 11 is coated with the high conductive liquid, the hot-met adhesive powder can be securely adhered onto the to-be-bonded area 11 under the effect of the electrostatic field, the spraying speed and the number of the spray heads 41 can be set according to the speed of the convey belt 2 to ensure the hot melt adhesive powder to adequately cover the surface of the shoe part 1, the spraying chamber 4 is further provided with at least one blowing device along the convey belt 2 (two air nozzles 42 in the present embodiment), after the hot melt adhesive powder is sprayed onto the surface of the shoe part 1, the air nozzles 42 can blow away the hot melt adhesive powder outside the to-be-bonded area 11 on the surface of the shoe part 1, the air nozzles 42 are connected to the air pump 422 through air supplying pipes 421, the flow speed and the number of the air nozzles 42 can be set according to the speed of the convey belt, and the direction of the air nozzles can be adjusted according to the position of the shoe part 1 to ensure the hot melt adhesive powder outside the to-be-bonded area 11 on the surface of the shoe part 1 to be removed completely, in order to recycle the hot melt adhesive powder which is blew down onto the convey belt 2, under the spraying chamber 4 and the convey belt 2 is disposed a powder-recycling chamber 43 that is connected to an air pressurized powder chamber (not shown) to recycle the hot melt adhesive powder into the air pressurized powder chamber for reuse by means of vacuum;

E. heating: the heating chamber 5 is located above the convey belt 2, the heating chamber 5 heats the hot melt adhesive powder on the to-be-bonded area 11 of the shoe part 1 by means of direct irradiation of infrared light, hot air flow, or microwave heating until the powder is melt. In the present embodiment, the heating chamber 5 is provided with infrared lamps 51 at an upper side thereof. The number of the infrared lamps 51 is set according to the temperature required for melting the hot melt adhesive powder and the speed of the convey belt 2. The temperature of the heating chamber 5 can be adjusted by a thermostat 52 disposed which controls the ON and OFF of the infrared lamps 51. The thermostat 52 can be installed on the inner surface of the heating chamber 5 or outside the heating chamber 5, optimally outside the heating chamber 5. The thermostat 52 is connected to a temperature sensor 53 disposed in the heating chamber 5 to control the temperature in the heating chamber 5. After being heated by the heating chamber 5, the hot melt adhesive powder on the to-be-bonded area 11 of the shoe part 1 will absorb the heat and then be melted into a liquid adhesive film ready to be bonded.

After the hot melt adhesive powder on the to-be-bonded area 11 of the shoe part 1 is melted, the shoe part 1 will be delivered by the convey belt 2 to be bonded to other shoe parts.

The above steps A and B can be combined into a single step by using a mixture of cleaning agent and high conductive liquid, such that the operation process can be simplified, saving the operation time.

With the above method, the hot melt adhesive powder can be automatically sprayed and melted without manual operation, enhancing the automation degree, reducing the labour intensity and saving the energy. In addition, the system of the present invention is provided with the powder-recycling chamber to prevent the escape of the powder, enhancing the utilization ratio of the powder, avoiding the environmental pollution, and protecting the health of the workers.

While we have shown and described various embodiments in accordance with the present invention, it is clear to those skilled in the art that further embodiments may be made without departing from the scope of the present invention.

What is claimed is:

1. A method for applying hot melt adhesive powder onto a sole or shoe part comprising the steps of:
applying cleaning agent: a cleaning agent is applied onto a to-be-bonded area of a surface of a to-be-bonded shoe;
irradiating: the surface of the to-be-bonded shoe is irradiated in a irradiation chamber by UVC and ozone;
applying conductive liquid: a conductive liquid which has a conductivity at least 100 times higher than water is applied onto the to-be-bonded area of the to-be-bonded shoe;
spraying hot melt adhesive powder: charged hot melt adhesive powder is sprayed onto the surface of the to-be-bonded shoe in a spraying chamber to make the charged hot melt adhesive powder attached onto the to-be-bonded area of the to-be-bonded shoe under the effect of an electrostatic field; and
heating: the to-be-bonded area on which is sprayed the hot melt adhesive powder is heated in a heating chamber to melt the hot melt adhesive powder.

2. The method for applying hot melt adhesive powder onto a sole or shoe part as claimed in claim 1, characterized in that: the step of applying cleaning agent and the step of applying conductive liquid are combined into a single step by using a mixture of cleaning agent and conductive liquid.

3. The method for applying hot melt adhesive powder onto a sole or shoe part as claimed in claim 1, characterized in that: the hot melt adhesive powder is a polyurethane adhesive powder.

4. The method for applying hot melt adhesive powder onto a sole or shoe part as claimed in claim 3, characterized in that: the hot melt adhesive powder is a thermo plastic Polyurethane.
